(19) United States
(12) Patent Application Publication
(10) Pub. No.: US 2024/0391248 A1
(43) Pub. Date: Nov. 28, 2024

(54) Method Of Applying Coating Medium, Coated Object, Control System And Coating System

(71) Applicant: ABB Schweiz AG, Baden (CH)

(72) Inventors: Yngve Finnestad, Sandnes (NO); Takahiro Tawata, Fujieda City, Shizuoka (JP)

(21) Appl. No.: 18/691,494

(22) PCT Filed: Sep. 16, 2021
(86) PCT No.: PCT/EP2021/075482

§ 371 Date: Mar. 13, 2024

(51) Int. Cl. B41J 2/21; B41J 2/14

(52) U.S. Cl. CPC B41J 2/2114; B41J 2002/14217

(57) ABSTRACT

A method of applying coating medium to a surface of an object, the method including applying coating medium to an inner region of the surface such that the coating medium on the inner region has an inner thickness; and applying coating medium to an outer region of the surface, adjacent to the inner region, to form an edge of the coating medium at a side of the outer region opposite to the inner region and such that the coating medium on the outer region has an outer thickness, wherein a minimum value of the outer thickness is 30% to 80% of the inner thickness, and wherein a maximum 10 value of the outer thickness is equal to or less than the inner thickness. A control system for controlling application of coating medium and a coating system for applying coating medium are also provided.

### TECHNICAL FIELD

The present disclosure generally relates to coating of objects. In particular, a method of applying coating medium to a surface of an object, an object having a surface to which a coating medium is applied by means of the method, a control system for controlling application of coating medium to a surface of an object, and a coating system for application of coating medium to a surface of an object, are provided.

### BACKGROUND

Automotive parts and many other objects may be painted using an atomizer. The atomizer generates a cloud of paint particles such that the paint is evenly distributed over a large area of the object. Inkjet painting is a new approach to automotive painting. Instead of dispersing a cloud of paint onto the object using an atomizer, an array of nozzles is used to apply paint in a controlled process.

EP 3628501 A1 discloses a method for printing an image on a surface comprising: printing, using a printhead mounted to an arm of a robot, a new image slice on the surface while moving the printhead over the surface along a rastering path; printing a reference line on the surface when printing the new image slice; sensing, using a reference line sensor, the reference line of an existing image slice while printing the new image slice; and adjusting the lateral position of the new image slice based on a sensed position of the reference line in a manner aligning a side edge of the new image slice with the side edge of the existing image slice.

### SUMMARY

One challenge with inkjet painting is how to handle edges of a printing pattern. Prior art inkjet printing methods create a sharp line separation between a painted area and a non-painted area. However, when there is a sudden change from 100% paint to 0% paint at the edge, gravity may cause the paint to sag outside the boundary of the intended printing pattern before the paint has dried. The sharpness of the printing pattern is thereby deteriorated. This type of sagging is quite noticeable and therefore affects the printing quality.

One object of the present disclosure is to provide an improved method of applying coating medium to a surface of an object.

A further object of the present disclosure is to provide a method of applying coating medium to a surface of an object, which method enables an improvement of edges of the coating medium.

A further object of the present disclosure is to provide a method of applying coating medium to a surface of an object, which method avoids sagging of coating medium outside the edge.

A still further object of the present disclosure is to provide a control system for controlling application of coating medium to a surface of an object, which control system solves one, several or all of the foregoing objects.

A still further object of the present disclosure is to provide a coating system for application of coating medium to a surface of an object, which coating system solves one, several or all of the foregoing objects.

According to a first aspect, there is provided a method of applying coating medium to a surface of an object, the method comprising applying coating medium to an inner region of the surface such that the coating medium on the inner region has an inner thickness; and applying coating medium to an outer region of the surface, adjacent to the inner region, to form an edge of the coating medium at a side of the outer region opposite to the inner region and such that the coating medium on the outer region has an outer thickness, wherein a minimum value of the outer thickness is 30% to 80% of the inner thickness, and wherein a maximum value of the outer thickness is equal to or less than the inner thickness.

Due to the reduction of the outer thickness in comparison with the inner thickness, a relatively low amount of coating medium will be placed at the outer region. In this way, a risk of sagging of the coating medium to outside the edge can be eliminated. In case the coating medium sags, the sagging will occur from the inner region to the outer region. In this way, the edge will stay sharp even if the coating medium sags after being applied. The edge may provide an outer contour of a coating pattern.

The outer thickness of the coating medium in the outer region at the edge is thus 30% to 100% of the inner thickness. Since the minimum value of the outer thickness is at least 30% of the inner thickness, a sharp edge can be maintained. Even if the edge might not be as significant immediately after application, the edge will be smooth and sharp after drying of the coating medium. When the outer thickness at the edge is less than approximately 20%, the edge will be less sharp and may appear jagged.

The method may leave an external uncoated region, outside the outer region, uncoated in the final object. The edge may be provided along all contours of the coating pattern where there will be a transition between the coating medium and the uncoated region in the final object. The method may further comprise drying of the coating medium to at least 80% prior to applying coating medium to the uncoated region.

The coating medium may be a liquid. Throughout the present disclosure, the coating medium may comprise paint.

A width of the outer region may be at least 2 mm and/or 20 mm or less, such as 10 mm. The width of the outer region may be substantially constant, or constant. A width of the inner region may be at least 20 mm. The outer region may transition directly to the inner region. A transition may thus be provided between the inner region and the outer region. The edge may be substantially parallel with, or parallel with, the transition line.

The application of the coating medium may be made by means of a printhead according to the present disclosure. The method may further comprise moving the printhead by means of a manipulator while applying the coating medium.

The surface of the object may for example be flat or curved. A thickness direction may be the normal of the surface. The surface may be substantially horizontally oriented, or horizontally oriented, when applying the coating medium thereto. The object may for example be an automotive part, such as a vehicle roof.

The minimum value of the outer thickness may be at least 40%, such as at least 50%, of the inner thickness. That is, the minimum value of the outer thickness may be 40% to 80%, such as 50% to 80%, of the inner thickness.

The inner thickness may be substantially constant, or constant. The inner thickness may for example be at least 1 um, such as at least 2 μm, such as 3 um. Alternatively, or in addition, the inner thickness may for example be less than 150 μm, such as less than 50 μm, such as less than 35 μm. Alternatively, or in addition, the inner thickness may for example be 1 um to 150 μm, such as 2 um to 50 μm, such as 3 um to 35 μm.

The outer thickness may decrease from the inner region towards the edge. The outer thickness may comprise a gradient towards the edge. The gradient may be determined based on a viscosity of the coating medium. A relatively steep gradient may be set for a relatively high viscosity, and vice versa. Alternatively, or in addition, a width of the outer region may be determined based on a viscosity of the coating medium. A relatively large width may be set for relatively low viscosities, and vice versa. A width of the outer region may be from the transition line to the edge.

The method may further comprise applying coating medium to the outer region such that a protruding wall is formed at the edge. In this way, the edge can be made even sharper while still avoiding sagging outside the edge. A thickness of the protruding wall may differ less than 50%, such as less than 20%, such as less than 10%, such as less than 5%, of the inner thickness. The protruding wall may run along an outer contour of the coating pattern. The protruding wall may protrude in the thickness direction, e.g. normal to the surface.

The coating medium may be applied to the outer region by using a noise pattern. The noise pattern may comprise a distribution of coating pixels to which the coating medium should be applied and non-coating pixels to which the coating medium should not be applied. The distribution may be a random distribution. The resulting thickness will be a function of the ratio between the coating pixels and the non-coating pixels.

The thickness of the applied coating medium may be said to be 100% if the coating medium is applied in equal amount to each pixel in the noise pattern. Correspondingly, the thickness of the applied coating medium may be said to be 50% if the coating medium is applied in equal amount to 50% of the pixels of the noise pattern.

The noise pattern may comprise blue noise. In blue noise, the coating pixels are more uniformly distributed than, for example, in binary white noise. There are thus no big visible groups of coating pixels in blue noise. A problem with inherent randomness can thereby be avoided. Blue noise is often used in computer graphics to simulate a gray color.

The noise pattern may have a gradually decreasing density from the inner region towards the edge.

The coating medium may be applied by an inkjet printer. The inkjet printer is one example of a printhead according to the present disclosure. The inkjet printer may comprise an array of nozzles. Each nozzle may be configured to eject single droplets of coating medium. The amount of coating medium in each droplet may be substantially equal, or equal. In this way, the thickness of the coating medium can be controlled by droplet spacing. During application of coating medium, the nozzles may be distanced 1 mm to 10 mm from the surface.

The nozzles may be binary. That is, at each application instance, each nozzle either applies coating medium of a given volume or does not apply coating medium. An inkjet printer comprising binary nozzles may be referred to as a digital inkjet printer. Alternatively, each nozzle may be controlled to eject a variable amount of coating medium. However, binary nozzles simplify application of the coating medium in a pixel pattern.

The coating medium may be applied to the inner region and to the outer region with a single stroke of a printhead. For example, a nozzle width spanned by the nozzles may be larger than a width of the outer region.

According to a second aspect, there is provided an object having a surface to which a coating medium is applied by means of the method according to the first aspect. The object may for example be a vehicle body.

According to a third aspect, there is provided a control system for controlling application of coating medium to a surface of an object, the control system comprising at least one data processing device and at least one memory having at least one computer program stored thereon, the at least one computer program comprising program code which, when executed by the at least one data processing device, causes the at least one data processing device to perform the steps of commanding application of coating medium to an inner region of the surface such that the coating medium on the inner region has an inner thickness; and commanding application of coating medium to an outer region of the surface, adjacent to the inner region, to form an edge of the coating medium at a side of the outer region opposite to the inner region and such that the coating medium on the outer region has an outer thickness, wherein a minimum value of the outer thickness is 30% to 80% of the inner thickness, and wherein a maximum value of the outer thickness is equal to or less than the inner thickness.

The at least one computer program may further comprise program code which, when executed by the at least one data processing device, causes the at least one data processing device to perform, or command performance of, any step according to the present disclosure. The at least one computer program may further comprise program code which, when executed by the at least one data processing device, causes the at least one data processing device to control a printhead and/or a manipulator according to the present disclosure.

According to a fourth aspect, there is provided a coating system for application of coating medium to a surface of an object, the coating system comprising the control system according to the third aspect and a printhead, wherein the control system is configured to control the printhead.

The printhead may comprise an inkjet printer. The inkjet printer may be of any type as described herein.

The coating system may further comprise a manipulator carrying the printhead. The manipulator may be programmable to move in at least one axis, such as in six or seven axes. The coating system may further comprise an industrial robot. The industrial robot may comprise a base and the manipulator movable relative to the base. The coating system may further comprise a supply unit for supplying coating medium to the printhead.

### BRIEF DESCRIPTION OF THE DRAWINGS

Further details, advantages and aspects of the present disclosure will become apparent from the following description taken in conjunction with the drawings, wherein:

FIG. 1: schematically represents a coating system and an object;

FIG. 2: schematically represents a cross-sectional side view of a nozzle head;

FIG. 3a: schematically represents a top view of a coating pattern applied according to the prior art;

FIG. 3b: schematically represents a cross-sectional side view of FIG. 3a;

FIG. 3c: schematically represents a top view of sagging of the coating pattern in FIGS. 2a and 2b;

FIG. 3d: schematically represents a cross-sectional side view of FIG. 3c;

FIG. 4a: schematically represents a top view of application of coating medium with a thinned outer region;

FIG. 4b: schematically represents a cross-sectional side view of FIG. 4a,

FIG. 4c: schematically represents a partial cross-sectional side view of FIG. 4b

FIG. 4d: schematically represents a noise pattern used when applying the coating medium; and

FIG. 5: schematically represents a partial cross-sectional side view of a further example of application of coating medium with a thinned outer region.

### DETAILED DESCRIPTION

In the following, a method of applying coating medium to a surface of an object, an object having a surface to which a coating medium is applied by means of the method, a control system for controlling application of coating medium to a surface of an object, and a coating system for application of coating medium to a surface of an object, will be described. The same or similar reference numerals will be used to denote the same or similar structural features.

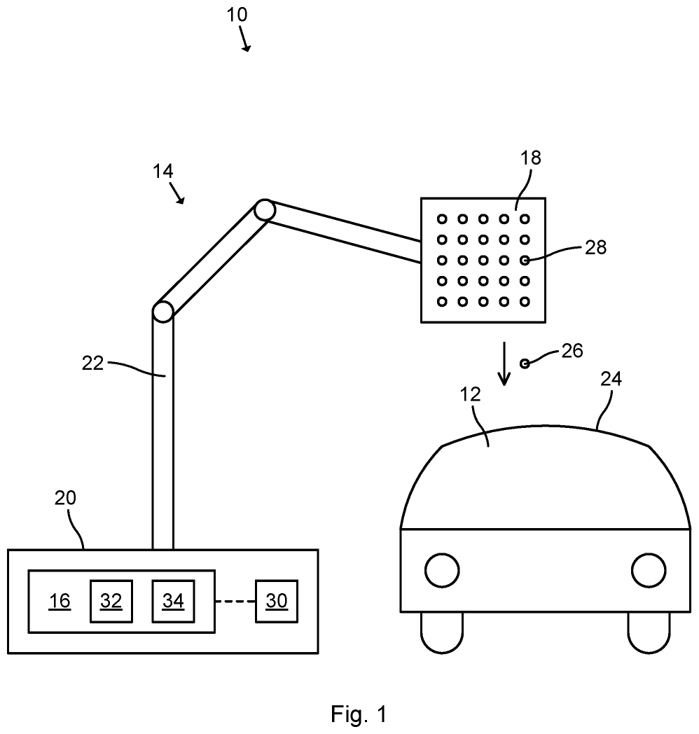

FIG. 1 schematically represents a coating system 10 and an object 12. The coating system 10 comprises an industrial robot 14, a control system 16 and an inkjet printer 18. The inkjet printer 18 is one example of a printhead according to the present disclosure.

The industrial robot 14 of this example comprises a base 20 and a manipulator 22 movable relative to the base 20, for example in six or seven axes. The inkjet printer 18 is carried by the manipulator 22, here at a distal end of the manipulator 22.

The object 12 is exemplified as a car. The object 12 comprises a surface 24, here exemplified as a roof surface of the car. An object according to the present disclosure is however not limited to cars and a surface 24 according to the present disclosure is not limited to surfaces of car bodies.

The inkjet printer 18 is configured to apply coating medium 26 to the surface 24. The inkjet printer 18 comprises a plurality of nozzles 28. In this example, the nozzles 28 are arranged in a matrix comprising rows and columns. The coating system 10 further comprises a supply unit 30. The supply unit 30 is configured to supply coating medium 26 to the inkjet printer 18.

The coating medium 26 is here exemplified as paint. The paint may be solventborne paint or waterborne paint.

The control system 16 comprises a data processing device 32 and a memory 34. The memory 34 has a computer program stored thereon. The computer program comprises program code which, when executed by the data processing device 32, causes the data processing device 32 to perform, or command performance of, various steps as described herein. In this example, the control system 16 controls the industrial robot 14, the supply unit 30 and the inkjet printer 18.

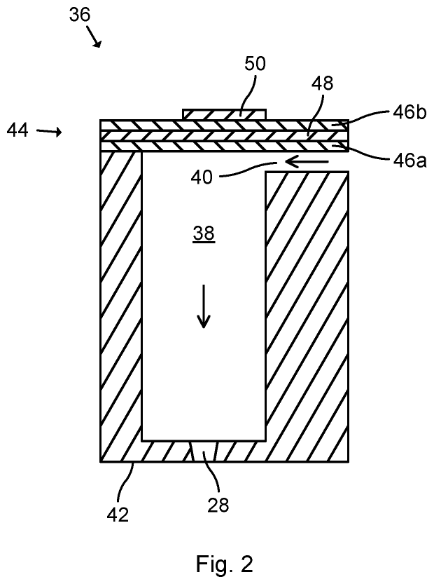

FIG. 2 schematically represents a cross-sectional side view of one specific example of a nozzle head 36 of the inkjet printer 18. The inkjet printer 18 of this example comprises a nozzle head 36 as shown in FIG. 2 for each nozzle 28. The nozzle head 36 comprises a pressurizing chamber 38. The pressurizing chamber 38 can be provided with coating medium 26 from the supply unit 30 via a supply path 40. FIG. 2 further shows that the nozzle 28 of the nozzle head 36 is provided at a discharge side 42 of the inkjet printer 18.

The nozzle head 36 comprises a piezoelectric substrate 44. The piezoelectric substrate 44 of this example comprises two piezoelectric ceramic layers 46a and 46b, a common electrode 48 and an individual electrode 50. The common electrode 48 is here positioned between the piezoelectric ceramic layers 46a and 46b. The second piezoelectric ceramic layer 46b is here positioned between the individual electrode 50 and the common electrode 48. The piezoelectric ceramic layers 46a and 46b can be expanded and contracted by applying a voltage from the outside of the nozzle head 36. The application of voltages is controlled by the control system 16. The common electrode 48 is electrically connected to corresponding common electrodes 48 of the other nozzle heads 36 of the inkjet printer 18.

The piezoelectric ceramic layers 46a and 46b are polarized in a thickness direction. When a voltage is applied to the individual electrode 50, the piezoelectric ceramic layers 46a and 46b are distorted due to the piezoelectric effect. Therefore, when a drive signal is applied to the individual electrode 50, the piezoelectric ceramic layers 46a and 46b become convex such that the supply path 40 opens, whereby the coating medium 26 is discharged. In this way, the nozzles 28 can work in a binary fashion to apply single droplets of coating medium 26 of uniform volume.

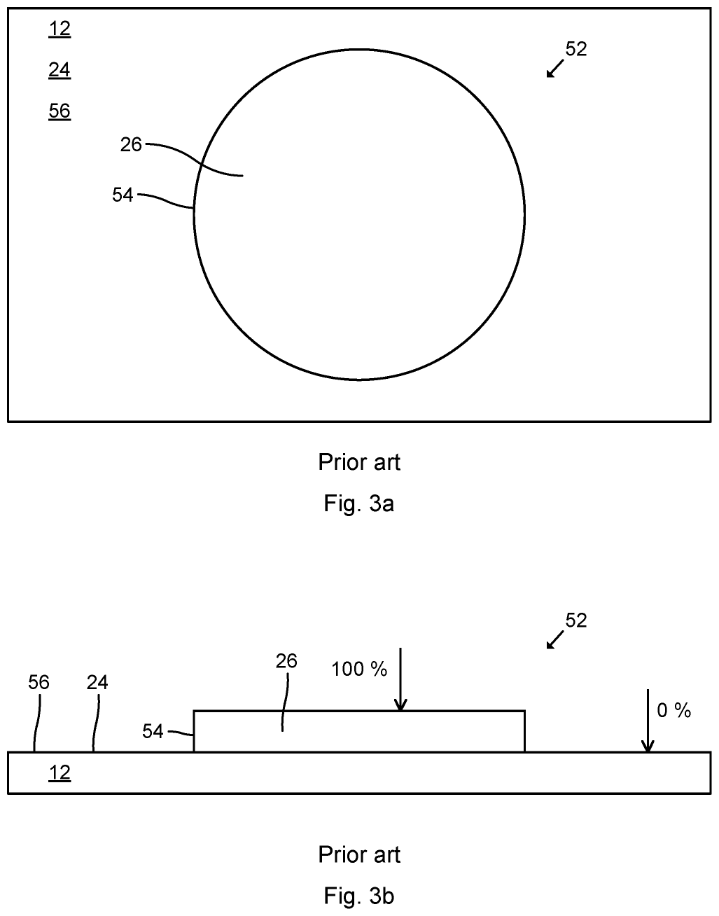

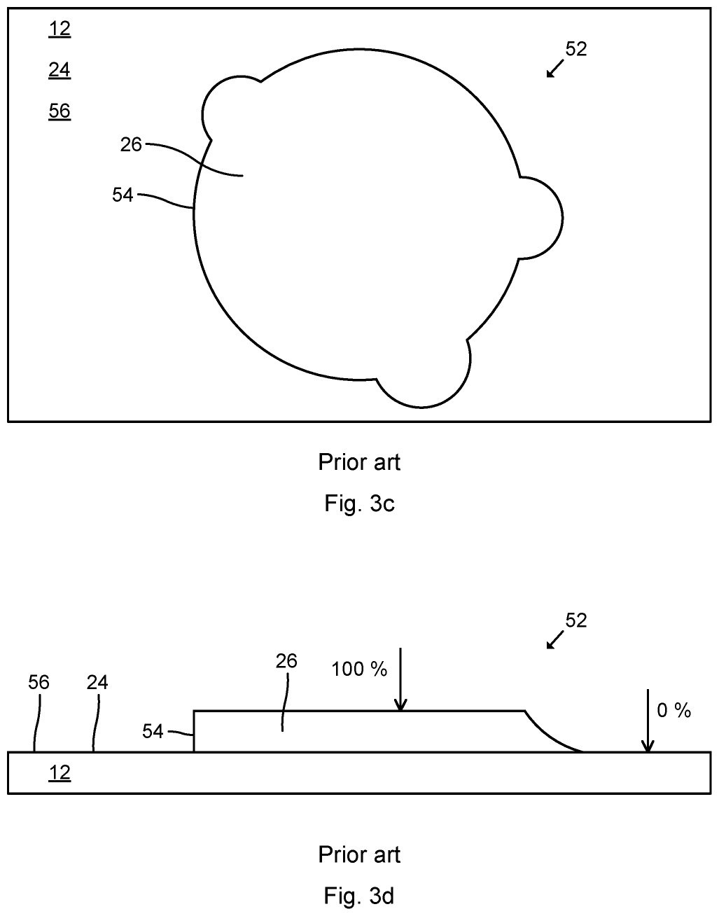

FIG. 3a schematically represents a top view of a coating pattern 52 applied to the surface 24 according to the prior art, and FIG. 3b schematically represents a cross-sectional side view of FIG. 3a. With collective reference to FIGS. 3a and 3b, the coating pattern 52 is provided onto the surface 24 by applying coating medium 26 from the inkjet printer 18. An edge 54 is thereby provided between the coating pattern 52 and an uncoated region 56 on the surface 24. As shown in FIG. 3b, the coating medium 26 is applied with a constant thickness all over the coating pattern 52. This thickness is indicated as 100% in comparison with 0% thickness at the uncoated region 56 where no coating medium 26 is applied. The edge 54 of the coating pattern 52 is a non-gradient edge.

FIG. 3c schematically represents a further top view of the coating pattern 52 in FIGS. 2a and 2b, and FIG. 3d schematically represents a cross-sectional side view of FIG. 3c. As shown in FIGS. 3c and 3d, the large amount of coating medium 26 applied close to the edge 54 causes the coating medium 26 to sag or fall outside the edge 54 before the coating medium 26 has dried. The sharpness of the coating pattern 52 is thereby deteriorated and the intended shape of the coating pattern 52 is not met by this coating method according to the prior art.

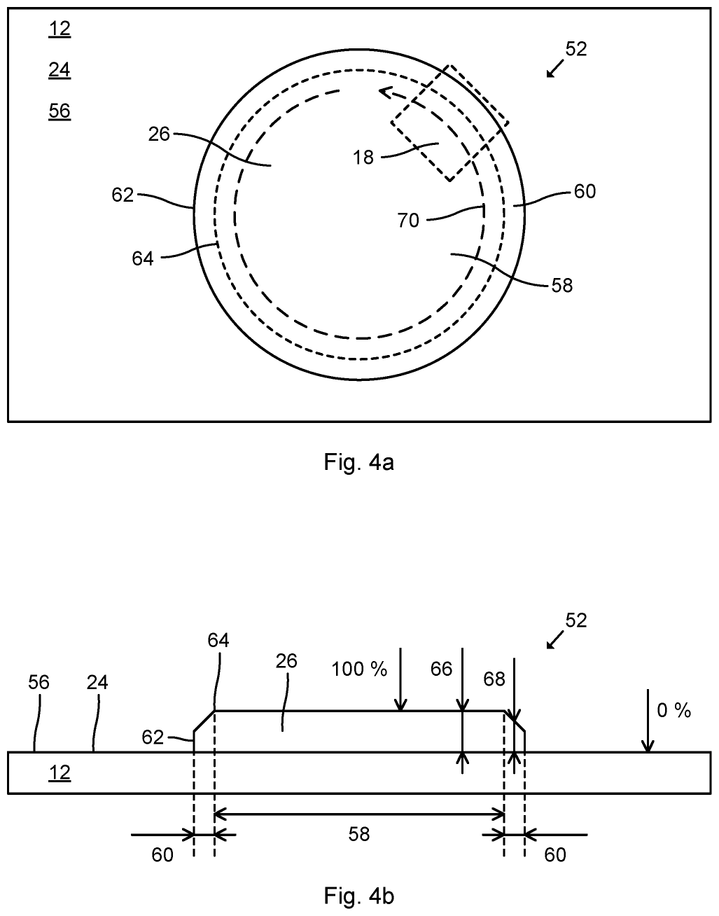

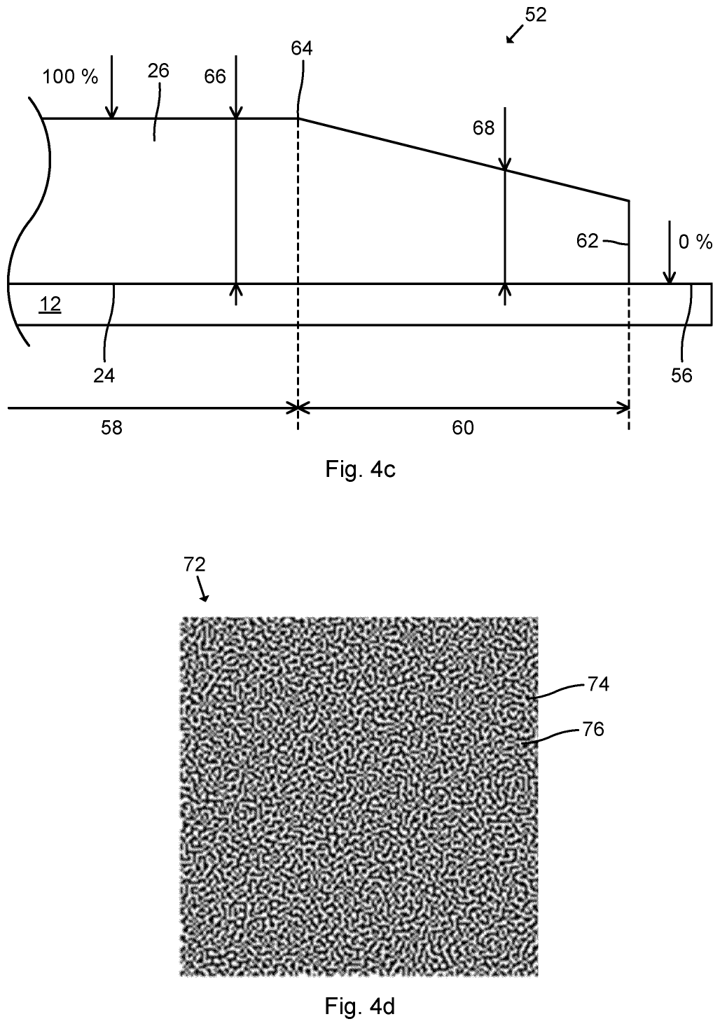

FIG. 4a schematically represents a top view of application of coating medium 26 to the surface 24 by means of a method according to the present disclosure, FIG. 4b schematically represents a cross-sectional side view of FIG. 4a, and FIG. 4c schematically represents an enlarged partial cross-sectional side view of FIG. 4b. With collective reference to FIGS. 4a to 4c, the coating pattern 52 is divided into an inner region 58 and an outer region 60. Thus, the coating medium 26 is applied to both the inner region 58 and to the outer region 60. The surface 24 shown in FIGS. 4a to 4c is flat but may alternatively be curved.

The coating medium 26 at an outer border of the outer region 60 forms an edge 62 of the coating pattern 52. The edge 62 is thus formed at a side of the outer region 60 opposite to the inner region 58. FIGS. 4a to 4c further show a transition line 64 between the inner region 58 and the outer region 60. The outer region 60 thus lies immediately adjacent to the inner region 58.

In this specific example where the coating pattern 52 is a circle, the outer region 60 is radially outside the inner region 58. The coating pattern 52 does however not need to be a circle. Some of many alternative types of coating patterns comprise lines, texts and logotypes. In many types of coating patterns, not only the external edges of the coating pattern need to be sharp, but also internal edges, such as if painting the letter “A”.

As shown in FIGS. 4b and 4c, the coating medium 26 on the inner region 58 has an inner thickness 66 and the coating medium 26 on the outer region 60 has an outer thickness 68. In this example, the inner thickness 66 is constant and is denoted as 100%. The inner thickness 66 may for example be 3 μm to 35 μm.

The outer thickness 68 of this example decreases linearly from 100% at the transition line 64 to 50% at the edge 62. The outer thickness 68 thereby comprises a gradient from the transition line 64 to the edge 62. A minimum value and a maximum value of the outer thickness 68 are thus 50% and 100%, respectively, of the inner thickness 66 in this specific example. The minimum value of the outer thickness 68 may be 30% to 80%, such as 40% to 80%, such as 50% to 80%, of the inner thickness 66. The maximum value of the outer thickness 68 may be equal to or less than the inner thickness 66. Due to the reduced amount of coating medium 26 applied to the outer region 60, the coating medium 26 at the outer region 60 is thinned.

A width of the outer region 60 may for example be 10 mm. In this example, the width of the outer region 60 is constant around the inner region 58. The transition line 64 is thereby parallel with the edge 62.

The coating medium 26 is applied by the inkjet printer 18 during movement of the manipulator 22. As shown in FIG. 4a, the coating medium 26 is applied over the entire width of the outer region 60 and over a part of the inner region 58 in a single stroke 70 of the inkjet printer 18. A width spanned by the nozzles 28 is thus larger than the width of the outer region 60.

Since a reduced amount of coating medium 26 is applied to the outer region 60 in comparison with the prior art method in FIGS. 3a to 3d, sagging of the coating medium 26 to the uncoated region 56 is avoided. Deterioration of the coating pattern 52 is thereby avoided and the coating pattern 52 is of higher quality than in the prior art (FIGS. 3a to 3d). Furthermore, by maintaining the outer thickness 68 at at least 30% of the inner thickness 66, the edge 62 will still be sharp after drying of the coating medium 26. Even though the sharpness may be slightly decreased due to the reduced outer thickness 68, this slight deterioration is neglectable in comparison with if sagging outside the edge 62 occurs. The reduced outer thickness 68 thus provides an improved transition between the outer region 60 and the uncoated region 56. The outer region 60 of this specific example has a minimum outer thickness 68 that is 50% of the inner thickness 66. However, this thickness difference between the inner region 58 and the outer region 60 is not visible for a human.

The reduced outer thickness 68 enables the edge 62 to be accurately positioned as desired while the structural integrity of the coating medium 26 can be better maintained until it has dried. The reduced outer thickness 68 also reduces the risk of bumps or craters to form in the coating medium 26.

A specific gradient of the coating medium 26 on the outer region 60 may be determined based on properties of the coating pattern 52 and/or of the coating medium 26, such as a viscosity of the coating medium 26.

Correspondingly, the width of the outer region 60 may be determined based on properties of the coating pattern 52 and/or of the coating medium 26.

After the coating medium 26 on the inner region 58 and the outer region 60 has dried, a further coating medium 26 may optionally be applied to the uncoated region 56 next to the coating pattern 52. Alternatively, a clearcoat may be added on top of the coating medium 26 and the uncoated region 56. Alternatively, no further coating is provided onto the coating pattern 52 and the uncoated region 56 is kept uncoated for the final object 12.

FIG. 4d schematically represents a noise pattern 72 used when applying the coating medium 26. The noise pattern 72 comprises coating pixels 74 and non-coating pixels 76. The noise pattern 72 of this example comprises 50% blue noise. As shown in FIG. 4d, there are no big clusters of coating pixels 74. The blue noise thereby enables a more smooth and uniform blending of the coating medium 26. The resulting thicknesses 66 and 68 are functions of the ratio between the coating pixels 74 and the non-coating pixels 76. The coating medium 26 can be applied to the outer region 60 by using a noise pattern 72 with a gradually decreasing density in order to provide the gradient towards the edge 62.

The coating pattern 52 may originate from an image. In this case, the position of one or more edges 62 of the coating medium 26 on the surface 24 may be determined by means of image processing. Examples of image processing operations that may be performed based on the image comprise masking the image, contour analysis, contour line dilation, a Gaussian blur, segmentation, a kernel operation, conversion of grayscale to blue noise and post processing.

Gaussian blur is a common method used in image processing to reduce the noise and detail in images. When blurring an image, the details are smoothened out. Technically, a Gaussian blur is a result of a convolution of an image matrix using a Gaussian function comprising a Gaussian kernel and a sigma value. By using a filter operation with a Gaussian kernel on the image, the Gaussian kernel can easily be modified based on the properties of the coating medium 26. The Gaussian kernel can be modified to adjust the width of the outer region 60. The slope of the gradient can be determined by the sigma value. By adjusting the Gaussian kernel and sigma value, it is possible to easily create the gradient of the coating medium 26 towards the edge 62 as desired.

The coating pattern 52 may be a representation of the processed image applied to the surface 24 where the coating medium 26 is applied to the regions of the surface 24 corresponding to the black regions in the processed image and where no coating medium 26 is applied to regions of the surface 24 corresponding to the white regions in the processed image.

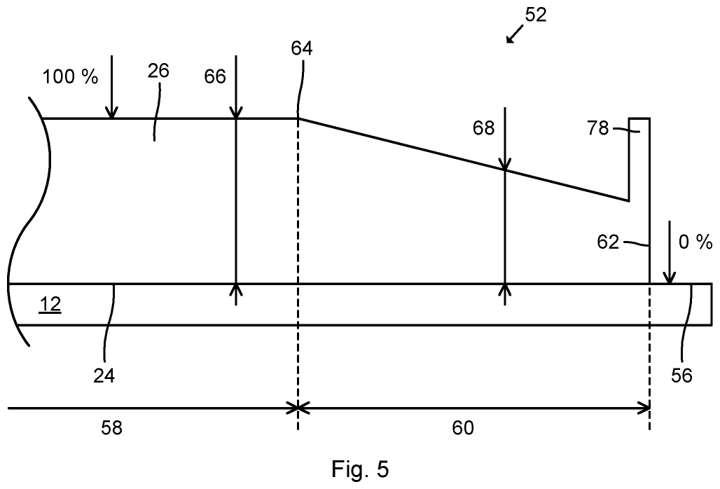

FIG. 5 schematically represents a partial cross-sectional side view of a further example of application of coating medium 26 with a thinned outer region 60. Also in this example, the outer thickness 68 decreases towards the edge 62. However, in FIG. 5, the coating medium 26 is applied to the outer region 60 such that a protruding wall 78 is formed at the edge 62. As shown, the protruding wall 78 extends in the thickness direction above the adjacent coating medium 26 in the outer region 60. The protruding wall 78 extends along the outer contour of the coating pattern 52. In this specific example, the outer thickness 68 at the protruding wall 78 is the same as the inner thickness 66. By means of the protruding wall 78 and the reduced amount of coating medium 26 applied to the outer region 60, the edge 62 can be made even sharper while still avoiding sagging of the coating medium 26 to the uncoated region 56.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto. Listing of All Claims Including Current Amendments

1. A method of applying coating medium to a surface of an object , the method comprising:
applying coating medium to an inner region of the surface such that the coating medium on the inner region has an inner thickness; and
applying coating medium to an outer region of the surface, adjacent to the inner region, to form an edge of the coating medium at a side of the outer region opposite to the inner region and such that the coating medium on the outer region has an outer thickness, wherein a minimum value of the outer thickness is 30% to 80% of the inner thickness, and wherein a maximum value of the outer thickness is equal to or less than the inner thickness.

2. The method according to claim 1, wherein the minimum value of the outer thickness is at least 40%, such as at least 50%, of the inner thickness.

3. The method according to claim 1, wherein the outer thickness decreases from the inner region towards the edge.

4. The method according to any claim 1, further comprising applying coating medium to the outer region such that a protruding wall is formed at the edge.

5. The method according to any claim 1, wherein the coating medium is applied to the outer region by using a noise pattern.

6. The method according to claim 5, wherein the noise pattern includes blue noise.

7. The method according to claim 5, wherein the noise pattern has a gradually decreasing density from the inner region towards the edge.

8. The method according to claim 1, wherein the coating medium is applied by an inkjet printer.

9. The method according to claim 1, wherein the coating medium is applied to the inner region and to the outer region with a single stroke of a printhead.

10. An object having a surface to which a coating medium is applied by a method including the steps of:
applying coating medium to a surface of an object, the method comprising:
applying coating medium to an inner region of the surface such that the coating medium on the inner region has an inner thickness;
applying coating medium to an outer region of the surface, adjacent to the inner region, to form an edge of the coating medium at side of the outer region opposite to the inner region and such that the coating medium on the outer region has an outer thickness, wherein a minimum value of the outer thickness is 30% to 80% of the inner thickness, and wherein a maximum value of the outer thickness is equal to or less than the inner thickness.

11. A control system for controlling application of coating medium to a surface of an object, the control system comprising at least one data processing device and at least one memory having at least one computer program stored thereon, the at least one computer program comprising including a program code which, when executed by the at least one data processing device, causes the at least one data processing device to perform the steps of:
commanding application of coating medium to an inner region of the surface such that the coating medium on the inner region has an inner thickness; and
commanding application of coating medium to an outer region of the surface, adjacent to the inner region, to form an edge of the coating medium at a side of the outer region opposite to the inner region and such that the coating medium on the outer region has an outer thickness, wherein a minimum value of the outer thickness is 30% to 80% of the inner thickness, and wherein a maximum value of the outer thickness is equal to or less than the inner thickness.

12. A coating system for application of coating medium to a surface of an object, the coating system comprising the a control system for controlling application of coating medium to the surface of the object, the control system including at least one data processing device and at least one memory having at least one computer program stored thereon, the at least one computer program including a program code which, when executed by the at least one data processing device, causes the at least one data processing device to perform the steps of;
commanding application of coating medium to an inner region of the surface such that coating medium on the inner region has an inner thickness;
commanding application of coating medium to an outer region of the surface adjacent to the inner region, to form an edge of the coating medium at a side of the outer region opposite to the inner region and such that the coating medium on the other region has an outer thickness, wherein a minimum value of the outer thickness is 30% to 80% of the inner thickness, and wherein a maximum of the outer thickness is equal to or less than the inner thickness;
and a printhead, wherein the control system is configured to control the printhead.

13. The coating system according to claim 12, wherein the printhead comprises-includes an inkjet printer.

14. The coating system according to claim 12, further comprising a manipulator carrying the printhead.

15. The method according to claim 2, wherein the outer thickness decreases from the inner region towards the edge.

16. The method according to claim 2, further comprising applying coating medium to the outer region such that a protruding wall is formed at the edge.

17. The method according to claim 2, wherein the coating medium is applied to the outer region by using a noise pattern.

18. The method according to claim 2, wherein the coating medium is applied by an inkjet printer.

19. The method according to claim 2, wherein the coating medium is applied to the inner region and to the outer region with a single stroke of a printhead.
